(19) United States
(12) Patent Application Publication
(10) Pub. No.: US 2023/0258542 A1
(43) Pub. Date: Aug. 17, 2023

(54) AN APPARATUS FOR COLLECTING FUNGAL SPORES FROM ATMOSPHERE, A METHOD THEREOF AND A DISEASE WARNING SYSTEM

(71) Applicants: UPL Corporation Limited, Port Louis (MU); UPL do Brasil Industria e Comercio de Insumos Agropecuarios S.A., Ituverava (BR)

(72) Inventors: Ayrton Berger Neto, Ituverava (BR); Sergio Tadeu Decaro Junior, Ituverava (BR); Rubens Amorim, Ituverava (BR); Rafael Henrique Alves Pereira, Ituverava (BR)

(21) Appl. No.: 18/013,447

(22) PCT Filed: Jun. 30, 2021
(86) PCT No.: PCT/BR2021/050287

§ 371 Date: Dec. 28, 2022

(30) Foreign Application Priority Data
Jun. 30, 2020 (BR) BR 102020013430.2
Jun. 30, 2021 (BR) BR 102021012966.2

(51) Int. Cl. G01N 1/22

(52) U.S. Cl. CPC G01N 1/2273; G01N 1/2214; G01N 2001/2279

(57) ABSTRACT

The present invention relates to an apparatus for collecting fungal spores in high altitudes comprising a container of closed structure, at least one chamber being connected to one inside end of the container, and at least one actuator connected to the closed end of the chamber. The present invention further relates to a method of collecting fungal spores from atmosphere using the apparatus and a disease warning system for Asian soybean rust.

### FIELD OF THE INVENTION

The present invention relates to collection and identification of fungi spores. Particularly, the present invention relates to an apparatus for collecting fungal spores in high altitudes and a method thereof.

### BACKGROUND OF THE INVENTION

Fungal spores are ubiquitous components of the atmosphere and move across landscapes and spore liberation takes different patterns. Many species release spores intermittently; others release spores at specific times of day. Spores may originate from fungal saprobes, pathogens, or symbionts. The atmospheric spore concentrations vary with climate, especially temperature, moisture, and wind, and hence vary daily.

Fungi have long been known to affect human wellbeing in various ways, including disease of essential crop plants, decay of stored foods with possible concomitant production of mycotoxins, superficial and systemic infection of human tissues, and disease associated with immune stimulation such as hypersensitivity pneumonitis and toxic pneumonitis. Plant diseases like powdery mildew, cercospora leaf spot, take all root rot, and anthracnose are caused by different fungal species.

Generally, the presence of these fungal spores in the crop areas are identified using disease warning systems based on meteorological variables such as rain forecast, temperature and moisture, but fail to consider initial pathogen entrance in the crop area. In some cases where the initial pathogen is considered, the disease warning systems are based on spores captured closer to the ground level.

CN207016771 discloses a fungal spore collection device including separation chamber, dust collecting device and vacuum pump.

CN106978332 discloses a sampling apparatus for a fungal spore in air.

J. M. Hirst et AL. disclose methods of measurement, vertical spore profiles and the detection of immigrant spores.

Conventional prediction systems do not consider the origin of detected spore and are based on local ground traps, by then it may be too late for the application of fungicide on the crops. Small is the correlation between the disease manifestation and the collected spores. Many other variables are assumed in order to obtain a pattern of disease prediction, based intensely on meteorological conditions, crop variety, among other which are complex and cannot themselves lead to accurate prediction.

Thus, there exists imminent need for a disease warning system, an apparatus and a method for collecting fungal spores to help farmers understand the origin of spores, its effectiveness and genetic differentiation, as well as the level of risk associated with meteorological conditions like wind direction and rain forecast.

### OBJECTS OF THE INVENTION

It is an object of the present invention to provide an apparatus for collecting fungal spores from the atmosphere.

Another object of the present invention is to provide an apparatus for collecting fungal spores in high altitudes.

Another object of the present invention is to provide an apparatus and a method for collecting fungal spores to help farmers understand the origin of spores, its effectiveness and genetic differentiation.

Another object of the present invention is to provide an apparatus to identify level of risk of fungal spores associated with meteorological conditions like wind direction and rain forecast.

Another object of the present invention is to provide a method of collecting fungal spores from atmosphere.

Another object of the present invention is to provide a disease warning system for Asian soybean rust.

Another object of the present invention is to provide an apparatus and method to identify collected spores as their levels of sensitivity to the fungicide modes of action so that the farmers can choose suitable fungicides to be used on the crops.

### SUMMARY OF THE INVENTION

An aspect of the present invention is to provide an apparatus for collecting fungal spores from atmosphere, said apparatus comprising:
a container of closed structure,
at least one chamber being connected to one inside end of the container, and
at least one actuator connected to the closed end of the chamber,
wherein the chamber is adapted for introducing at least one sample blade comprising an adhesive layer and being adapted for capturing fungal spores, and
wherein the actuator enables opening and closure of the chamber.

Another aspect of the present invention is to provide an apparatus for collecting fungal spores from atmosphere, said apparatus comprising:
a container of closed structure,
a first chamber being connected to one inside end of the container,
a second chamber being connected to one inside end of the container,
a third chamber being connected to one inside end of the container,
a first actuator connected to the closed end of the first chamber,
a second actuator connected to the closed end of the second chamber, and
a third actuator connected to the closed end of the third chamber,
wherein the chambers are adapted for introducing at least one sample blade comprising an adhesive layer and being adapted for capturing fungal spores, and
wherein the actuators enable opening and closure of the chambers.

Yet another aspect of the present invention is to provide a method of collecting fungal spores from atmosphere using the apparatus, said method comprising:
providing an apparatus comprising a container of closed structure, at least one chamber being connected to one inside end of the container, and at least one actuator connected to the closed end of the chamber to a flying means;
allowing the flying means to reach a predetermined altitude from the ground level;
opening at least one chamber containing at least one sample blade by activating at least one actuator using a control means when the flying means reaches a predetermined altitude;
allowing the chamber to collect spores from the atmosphere;
allowing the flying means to return to the ground level; and
removing, from the chamber, the sample blades containing spores collected from atmosphere.

Yet another aspect of the present invention is to provide a disease warning system for Asian soybean rust, said system comprising:
an apparatus for collecting fungal spores from atmosphere; said apparatus comprising:
a container of closed structure,
at least one chamber being connected to one inside end of the container, and
at least one actuator connected to the closed end of the chamber,
and a control unit operatively coupled to the apparatus and configured to send and/or receive data pertaining to any or a combination of collected fungal spores, data pertaining to metrological conditions and/or data pertaining to any or a combination of agricultural field.

### BRIEF DESCRIPTION OF THE INVENTION

The accompanying drawings are included to provide a further understanding of the present disclosure and are incorporated in and constitute a part of this specification. The drawings illustrate exemplary embodiments of the present disclosure and, together with the description, serve to explain the principles of the present disclosure. The diagrams are for illustration only, which thus is not a limitation of the present disclosure.

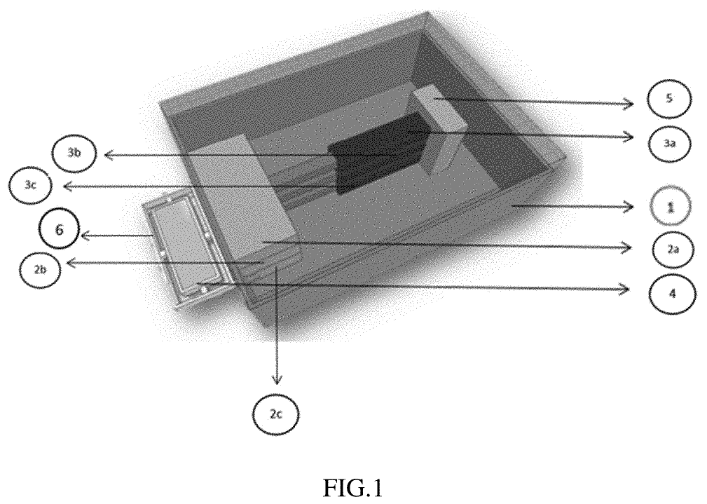

FIG. 1 illustrates an exemplary apparatus for collecting fungal spores from atmosphere, in accordance with an embodiment of the present invention.

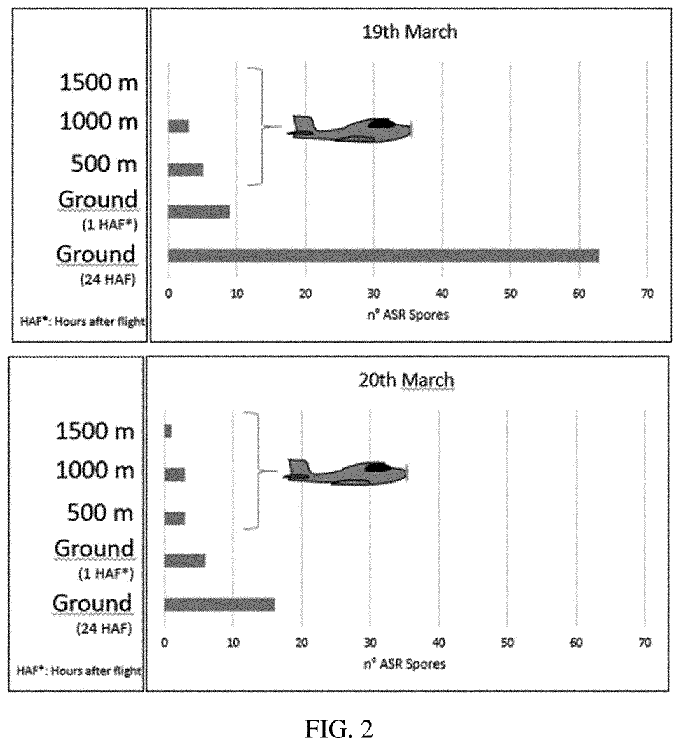

FIG. 2 shows number of Phakopsora pachyrhizi spores collected at the ground and varying altitudes from the ground.

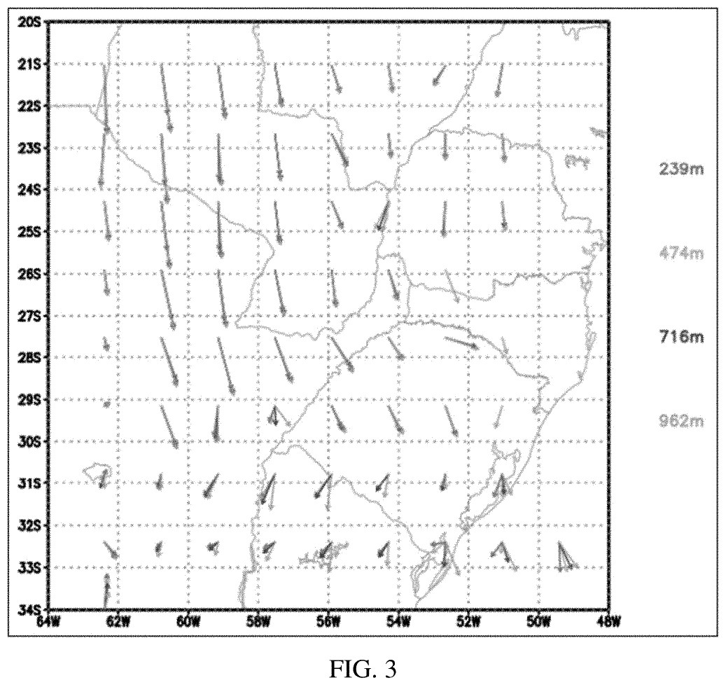

FIG. 3 illustrates the wind direction and intensity (m/s) forecast per altitude from Paraguay entering the Brazil region on Sep. 30, 2020.

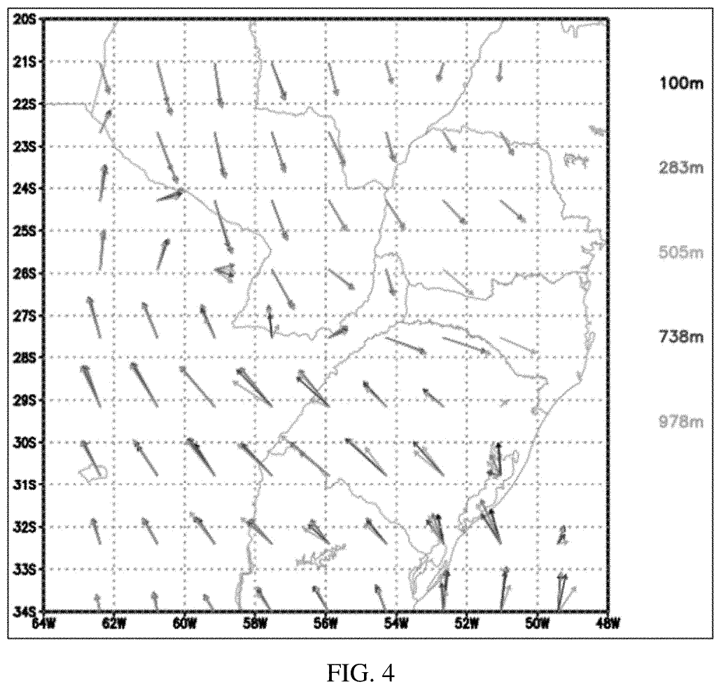

FIG. 4 illustrates the wind direction and intensity (m/s) forecast per altitude from Paraguay entering the Brazil region on Oct. 1, 2020.

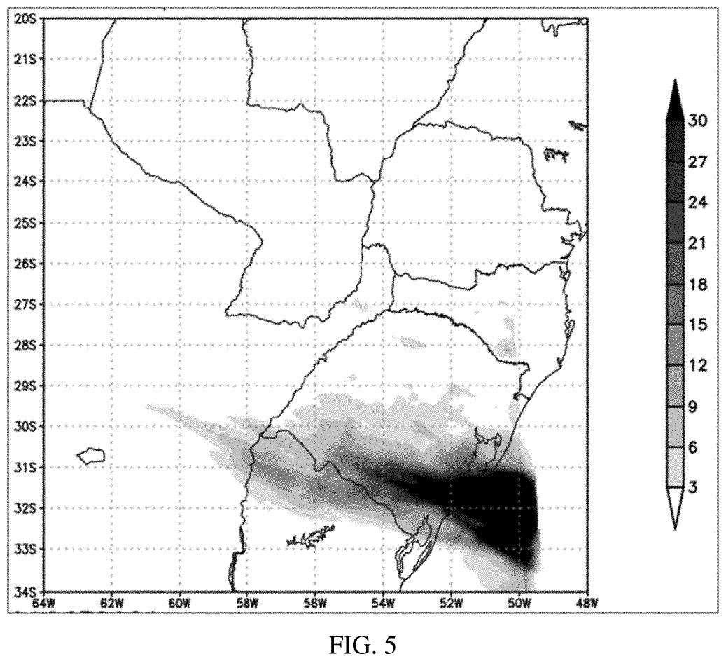

FIG. 5 illustrates the accumulated rain forecast (mm/day) on Sep. 30, 2020.

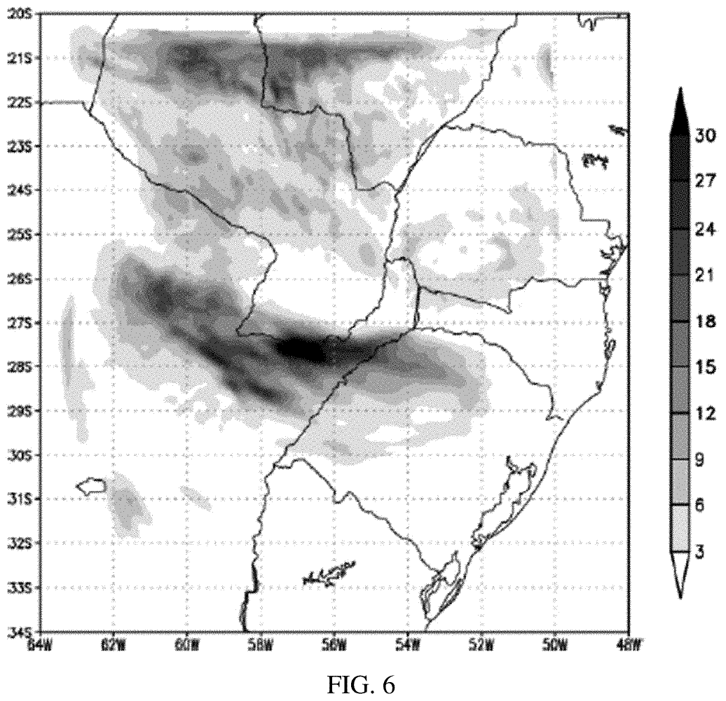

FIG. 6 illustrates the accumulated rain forecast (mm/day) on Oct. 1, 2020.

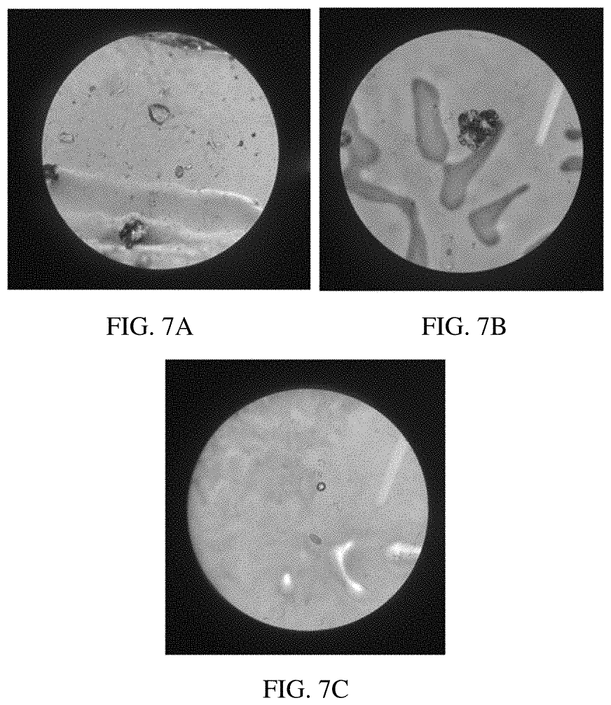

FIG. 7 illustrates microscopic images of Phakospora pachyrhizi collected from the high altitudes.

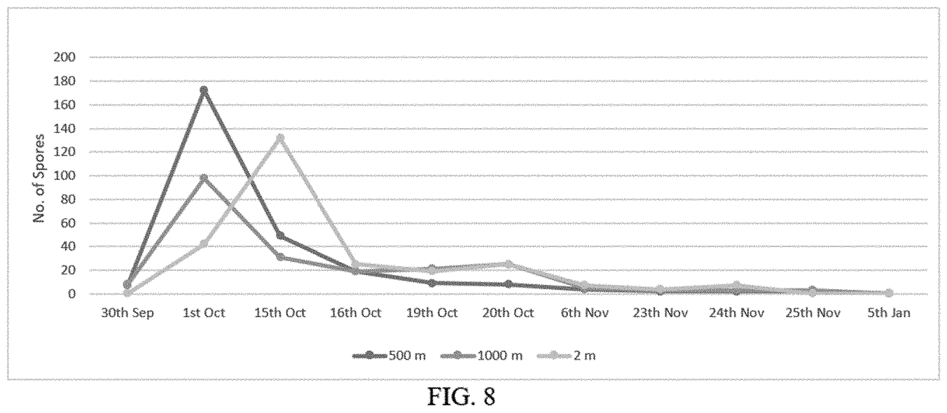

FIG. 8 illustrates a graphical representation of the number of spores collected at high altitudes from ground at São Luiz Gonzaga—RS State, Brazil.

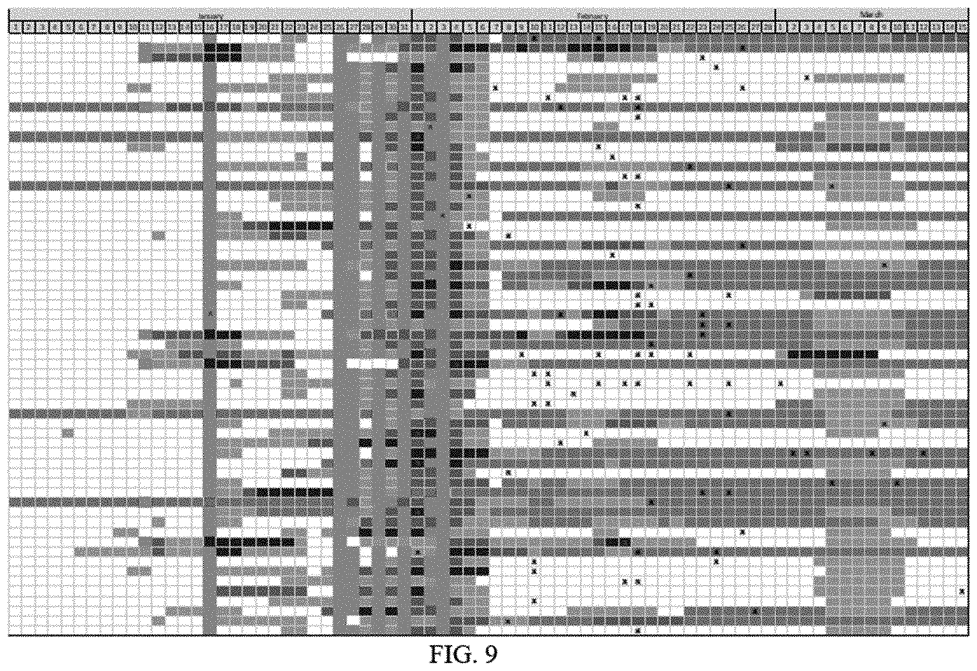

FIG. 9 illustrates Asian Soybean Rust occurrence map for RS State in the season from January to March 2021.

### DETAILED DESCRIPTION OF THE INVENTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein and as being contemplated herein would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment” and similar language throughout this specification may, but not necessarily, all refer to the same embodiment.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced items. Further, the use of terms “first”, “second”, and “third”, and the like, herein do not denote any order, quantity, or importance, but rather are used to distinguish one element from another.

The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all groups used in the appended claims.

Unless otherwise defined, all technical and scientific terms used herein have the same meaning as commonly understood by one of ordinary skilled in the art to which this invention belongs. The system, methods, and examples provided herein are illustrative only and not intended to be limiting.

Embodiments of the present invention will be described below in detail with reference to the accompanying drawings.

The present invention provides an apparatus for collecting fungal spores from atmosphere comprising a container of closed structure, at least one chamber being connected to one inside end of the container, and at least one actuator connected to the closed end of the chamber.

In an embodiment, the fungal spores include but are not limited to Corynespora cassiicola, Cercospora spp., Erysiphe spp., Septoria glycines, Colletotrichum spp., Puccinia polysora, Puccinia sorghi, Exserohilum turcicum, Cercospora zeae-maydis, Stenocarpella maydis, Ramularia areola, P. recondita f. sp. tritici, Blumeria graminis f.sp. tritici, Drechslera tritici repentis, Pyricularia grisea, Gibberella zeae, Alternaria spp., Botrytis spp., Venturia spp., Plasmopora spp., Phomopsis spp., Diplocarpon rosae, Fusarium spp., Thielaviopsis spp., Verticillium spp., Magnaporthe grisea, Colletotrichum gloeosporioides, Rhizoctonia solani, Phakospora pachyrhizi, Ganoderma zonatum, Myxomycetes, Pythium spp., and Phytophthora spp.

In a preferred embodiment, the fungal spores are Phakospora pachyrhizi.

In an embodiment, the open end of the chamber is connected to the one inside end of the container.

In an embodiment, the chamber is adapted for introducing at least one sample blade comprising an adhesive layer and being adapted for capturing the fungal spores. In an embodiment, the chamber comprises a tray to adopt the sample blade.

In an embodiment, the chamber is configured to open and close at predetermined altitude for predetermined interval of time. In an embodiment, the predetermined altitude ranges from 100 m to 10,000 m above the ground level. In a preferred embodiment, the predetermined altitude ranges from 500 m to 5000 m above the ground level. In a most preferred embodiment, the predetermined altitude ranges from 500 m to 1500 m above the ground level. In an embodiment, the predetermined interval of time is 1 minute or more. In a preferred embodiment, the predetermined interval of time is between 1 minute to 300 minutes. In a most preferred embodiment, the predetermined interval of time is between 5 minutes to 20 minutes.

In an embodiment, the sample blade is made of materials selected from glass and fiber. In a preferred embodiment, the sample blade is made of glass.

In an embodiment, the actuator enables opening and closure of the chamber. In an embodiment, the actuator is operated using control means selected from remote sensor, Bluetooth, and wireless network.

By way of a non-limiting example, the apparatus is capable of being connected to a flying means. In an embodiment, the flying means include but are not limited to balloon, aircraft, and drones.

In an embodiment, the apparatus for collecting fungal spores from atmosphere enables collection of fungal spores from high altitudes. The thus collected fungal spores are further evaluated to identify the specific fungal spores collected on the sample blade.

FIG. 1 illustrates an exemplary apparatus for collecting fungal spores from atmosphere, in accordance with an embodiment of the present invention. Notwithstanding the above, the first chamber (2a), second chamber (2b) and the third chamber (2c) are collectively termed chambers (2). Notwithstanding to the above, the first actuator (3a), second actuator (3b) and the third actuator (3c) are collectively termed actuators (3).

Referring to FIG. 1, an apparatus for collecting fungal spores from atmosphere comprises a container (1) of closed structure, a first chamber (2a) being connected to one inside end of the container (1), a second chamber (2b) being connected to one inside end of the container (1), a third chamber (2c) being connected to one inside end of the container (1), a first actuator (3a) connected to the closed end of the first chamber (2a), a second actuator (3b) connected to the closed end of the second chamber (2b), and a third actuator (3c) connected to the closed end of the third chamber (2c). The first chamber (2a), second chamber (2b) and the third chamber (2c) are placed next to each other. Each chamber (2) is adapted for introducing a sample blade (4) which comprises an adhesive layer and enables capturing of fungal spores. The first, second and third actuators (3) enable opening and closure of the first, second and third chambers (2), respectively. The actuators (3) are fixed to the container (1) using a support (5). The one end of each actuators (3) are connected to the other end of each chambers (2). The other end of each actuators (3) are connected to the support (5). The chamber comprises a tray (6) to receive the sample blade.

According to an exemplary embodiment, the first chamber (2a) is configured to open at first predetermined altitude above the ground level. The second chamber (2b) is configured to open at a second predetermined altitude higher than the first predetermined altitude. The third chamber (2c) is configured to open at a third predetermined altitude higher than the second predetermined altitude. In a preferred embodiment, the first predetermined altitude is 500 m above the ground level. In a preferred embodiment, the second predetermined altitude is 1000 m above the ground level. In a preferred embodiment, the third predetermined altitude is 1500 m above the ground level.

According to an exemplary embodiment, the first, second and third chambers (2) are configured to open for predetermined interval of time. In a preferred embodiment, the first, second and third chambers (2) are configured to open for 10 minutes to 30 minutes. In a most preferred embodiment, the first, second and third chambers (2) are configured to open for 20 minutes.

In another embodiment, the present invention provides a method of collecting fungal spores from atmosphere comprising the steps of attaching, to a flying means, an apparatus comprising a container of closed structure, at least one chamber being connected to one inside end of the container, and at least one actuator connected to the closed end of the chamber, allowing the flying means to reach a predetermined altitude from the ground level, opening at least one chamber containing at least one sample blade by activating at least one actuator using a control means when the flying means reaches a predetermined altitude, allowing the chamber to collect spores from the atmosphere, allowing the flying means to return to the ground level, and removing, from the chamber, the sample blades containing spores collected from atmosphere.

In an embodiment, the sample blade comprises an adhesive layer. In an embodiment, the adhesive layer of the sample blade enables the fungal spores in the atmosphere to get adhered to it, thus capturing the fungal spores.

In an embodiment, the method further enables to capture data pertaining to metrological conditions such as wind predominant direction at the collecting altitudes and rain forecast.

In an embodiment, the collected fungal spores are further analyzed to determine the species of fungi and number and viability of spores. In another embodiment, the collected spores are further identified with resistance genes. In another embodiment, the collected fungal spores can be used for evaluation of disease evolution in fields closer to the apparatus. In an embodiment, the collected fungal spores are compared with the data of spores collected at ground level.

In an embodiment, the method of collecting fungal spores from atmosphere enables to identify which agrochemicals to be used at the region where the fungal spores are collected. The method enables to determine an appropriate timing of sprays of agrochemical and the choice of the more appropriate fungicides to protect the crops.

In an embodiment, the appropriate timing of sprays of agrochemical and the choice of the more appropriate fungicides to protect the crops are determined based on the data pertaining to any or a combination of collected fungal spores and data pertaining to meteorological conditions.

In an embodiment, the crops include but are not limited to Brassicas such as Asian leafy brassicas, onions, peas, lettuce, celery, spinach, kale, herbs, cucurbits, cucumber, melons, pumpkin, zucchini, parsnip, beetroot, potato, peas, bitter melon, tomato, capsicum, Brussels sprouts, cabbage, swedes, beans, soybean, carrot, garlic, spring onions, leeks, eggplant, sweet potato, and corn. In a preferred embodiment, the crop is soybean.

In an embodiment, the flying means include but are not limited to balloon, aircraft, and drones.

In an embodiment, the agrochemicals to-be-used can include any or a combination of fertilizers, insecticides, fungicides, pesticides, herbicides, nematicides, and nutrient rich chemicals, but not limited to the likes. In a preferred embodiment, the agrochemical to-be-used is fungicides.

In another embodiment, the present invention provides a disease warning system comprising an apparatus for collecting fungal spores from atmosphere; said apparatus comprising a container of closed structure, at least one chamber being connected to one inside end of the container, and at least one actuator connected to the closed end of the chamber, and a control unit operatively coupled to the apparatus that can be configured to send and/or receive data pertaining to any or a combination of collected fungal spores, data pertaining to metrological conditions and/or data pertaining to any or a combination of agricultural field.

In an embodiment, the disease warning system enables one or more operating users to connect to a network of the system to allow the operating users to feed data pertaining to any or a combination of collected fungal spores. The data pertaining to any or a combination of collected fungal spores include but are not limited to the species of fungi, sensitivity of spores, number and viability of spores, result from identification of spores with resistance genes, result from evaluation of disease evolution in fields closer to the apparatus, agrochemicals to-be-used and comparison result to the data collected at the ground level. In an embodiment, the agrochemicals to-be-used can include any or a combination of fertilizers, insecticides, fungicides, pesticides, herbicides, nematicides, and nutrient rich chemicals, but not limited to the likes.

In an embodiment, the system further allows the operating user to connect to a network of the system to allow the operating users to feed data pertaining to metrological conditions including but not limited to wind predominant direction at the collecting altitudes, wind intensity, rain forecast and rain intensity. The data pertaining to metrological conditions further allows the operating users to understand where and when to start collecting spores from the atmosphere.

In an embodiment, the control unit can be positioned at a remote location and can be configured to send and/or receive data pertaining to any or a combination of the collected fungal spores from the remote location by a wireless/wired media, but not limited to the likes.

In an embodiment, the system can be implemented in form of a network where one or more end users can be connected to the system. The system can include one or more operating users who can connect to the end users and the system through the network. In an embodiment, the end users are farmers.

In an embodiment, the disease warning system enables one or more end users to connect to a network of the system to allow the end users to feed data pertaining to any or a combination of agricultural field. The data pertaining to any or a combination of agricultural field include but are not limited to polygon coordinates of the agricultural area, crop name and sowing date.

In an embodiment, the system allows to determine disease risks at one or more regions. In an embodiment, the disease risks at one or more regions are determined based on data related to fungal spores captured in high altitude or at ground level for one or more regions of wind flow, rain occurrence at the region where fungal spores are collected, fungal spores captured from rain drops at ground level, and weather conditions at one or more region before the spore collection. In an embodiment, the system allows to bifurcate the disease risks at one or more regions from very low risks to extremely high risks. In an embodiment, the system automatically determines the agrochemicals to-be-used based on the disease risks. The system can send this data pertaining to the agrochemicals to-be-used to the end users so that the end users can use the appropriate agrochemical on the crops at a right time.

In an embodiment, the system allows bifurcation of the disease risks at one or more regions from very low risks to extremely high risks based on spore collections in altitude and from the ground, wind, rain and meteorological favorability conditions, and crop cycle parameters of days after sowing and date of sowing.

In an embodiment, the system allows bifurcation of the disease risks at one or more regions from low risks to high risks based on the favorability of meteorological parameters. The meteorological parameters include air humidity, average temperature, dew depression point and maximum temperature.

In an embodiment, the system allows bifurcation of the disease risks at one or more regions from low risks to high risks based on the number of spores collected closer to the ground. In another embodiment, the system allows bifurcation of the disease risks at one or more regions from low risks to high risks based on the wind direction at 500 m from the ground. In another embodiment, the system allows bifurcation of the disease risks at one or more regions from low risks to high risks based on the wind direction at 1000 m from the ground. In another embodiment, the system allows bifurcation of the disease risks at one or more regions from low risks to high risks based on the number of spores collected in altitude. In another embodiment, the system allows bifurcation of the disease risks at one or more regions from low risks to high risks based on the rain duration. In another embodiment, the system allows bifurcation of the disease risks at one or more regions from low risks to high risks based on the rain intensity. In an embodiment, the system allows bifurcation of the disease risks at one or more regions from low risks to high risks based on the number of spores collected closer to the ground. In another embodiment, the system allows bifurcation of the disease risks at one or more regions from low risks to high risks based on the crop sowing date. In another embodiment, the system allows bifurcation of the disease risks at one or more regions from low risks to high risks based on the days after the crop sowing.

Therefore, in an embodiment, the method of the present invention comprises collecting spores periodically, following 15 days of interval between each collection.

In an embodiment, the method of the present invention comprises collecting spores at high altitudes from ground periodically, following 10-20 days interval of significant wind direction. In a preferred embodiment, the method of the present invention comprises collecting spores at high altitudes from ground periodically, following 10-20 days interval of wind stream with an intensity of at least 15 km/h and durability of at least 12 hours, one day before the spore collection.

In an embodiment, the method of the present invention comprises collecting spores within a period of 12 hours after an intense wind stream occurrence.

In an embodiment, the method of the present invention comprises collecting spores within a period of 12 hours after an intense wind stream occurrence of at least 50 km/h at 1000 m lasting for a minimum of 12 continuous hours.

In an embodiment, the method of the present invention comprises collecting spores within a period of 12 hours after a rain of at least 5 mm/day.

In an embodiment, the method of the present invention comprises collecting spores within a period of 12 hours after a rain of at least 7 mm/day.

In an embodiment, the method of the present invention comprises collecting spores within a period of 12 hours after a rain of at least 8 mm/day.

In an embodiment, the system can be implemented using any or a combination of hardware components and software components such as a cloud, a server, a computing system, a computing device, a network device and the like. Further, the system can interact with the operating users and the end users through a mobile application that can reside in the mobile devices of the operating users and the end users. In an implementation, the system can be accessed by application that can be configured with any operating system, including but not limited to, Android, iOS, and the like.

Further, the network can be a wireless network, a wired network or a combination thereof that can be implemented as one of the different types of networks, such as Intranet, Local Area Network (LAN), Wide Area Network (WAN), Internet, and the like. Further, the network can either be a dedicated network or a shared network. The shared network can represent an association of the different types of networks that can use variety of protocols, for example, Hypertext Transfer Protocol (HTTP), Transmission Control Protocol/Internet Protocol (TCP/IP), Wireless Application Protocol (WAP), and the like.

In an embodiment, the system can facilitate an interaction between the operating users and the end users through the network. The operating users can send a set of data pertaining to the any or combination of collected fungal spores, into the system, using the mobile devices. The system can receive the data and transmit the received data to mobile devices of the end users. The data pertaining to any or a combination of collected fungal spores include but are not limited to the species of fungi, sensitivity of spores, number and viability of spores, result from identification of spores with resistance genes, result from evaluation of disease evolution in fields closer to the apparatus, agrochemicals to-be-used and comparison result to the data collected at the ground level. The system can send this data pertaining to the agrochemicals to-be-used to the end users so that the end users can use the appropriate agrochemical on the crops at a right time.

In an exemplary embodiment, the mobile devices can include but are not limited to smartphone, laptop, computer, and hand-held computing devices.

In an embodiment, the system can facilitate authentication of the operating users and the end users so that only authorized users can access the system.

In an exemplary embodiment, the present invention provides a disease warning system for Asian soybean rust comprising an apparatus for collecting Phakopsora pachyrhizi from atmosphere; said apparatus comprising a container of closed structure, at least one chamber being connected to one inside end of the container, and at least one actuator connected to the closed end of the chamber, and a control unit operatively coupled to the apparatus that can be configured to send and/or receive data pertaining to any or a combination of collected Phakopsora pachyrhizi.

As used herein, and unless the context dictates otherwise, the term “coupled to” is intended to include both direct coupling (in which two elements that are coupled to each other or in contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

Advantageously, the present invention allows collection of fungal spores to help farmers understand the origin of spores, its effectiveness and genetic differentiation, as well as the level of risk associated with meteorological conditions like wind direction and rain forecast.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### EXAMPLES

Example 1: Trials were conducted to validate if the apparatus of the present invention is able to collect Phakopsora pachyrhizi spores in altitude and identify the best altitude from the ground to collect spores and identifying role of wind streams and rainy cloud formation in the interference on spores' flux. In the examples, the terms ‘Asian Soybean Rust’ (ASR) and Thakopsora pachyrhizi are used interchangeably. Phakopsora pachyrhizi is an obligate biotrophic pathogen that causes Asian soybean rust.

Collection of Spores in High Altitudes from Ground:

The apparatus for collecting fungal spores according to the present invention was attached to an Aircraft and remotely operated from cockpit to fly in São Luiz Gonzaga City, Rio Grande do Sul State, Brazil. The days chosen to fly were 16, 19 and 20 Mar. 2020. These days were selected on purpose because a rain was expected for 17 and 18 Mar. 2020 which allowed to check influence of rain occurrence on spores' dynamics in the atmosphere. A specific flying time of 3 pm was adhered when meteorological conditions were more favorable to spores moving due to thermic inversion.

The pilot inside the cockpit opened chambers of the apparatus when the desired altitude is reached using a remote radio control. Each chamber in the apparatus of the present invention comprised a fixed microscopical glass blade with a sticker to retain the spore when opened. The chambers were opened at altitudes 500 m, 1000 m and 1500 m from the ground, respectively. Each chamber was opened for 20 minutes, only one chamber was opened at a time. During flying between the altitudes and/or during the takeoff and landing, the chambers were kept closed to avoid interference of particles and spores at undesired heights or closer to the ground. After collecting the spores from desired altitudes of 500 m, 1000 m and 1500 m from the ground, the blades from each chamber were removed and taken to laboratory for counting spores.

Collection of Spores from Ground:

A ground spore trap containing one glass blade was positioned in a soybean crop area 500 m from the Aircraft landing track. Ground collections were taken in two ways: at the same period of time used for the flights (˜1 hour) and 24 hours after the flight (overnight).

### Results:

FIG. 2 shows the number of Phakopsora pachyrhizi spores collected at the ground and varying altitudes from the ground. Table 1 shows comparison of the meteorological conditions and collection of spores at altitudes from the ground.

| Meteorological | | | | | |
|---|---|---|---|---|---|
| conditions/Spore | | | | | |
| collection | 16^{th} Mar. 2020 | 17^{th} Mar. 2020 | 18^{th} Mar. 2020 | 19^{th} Mar. 2020 | 20^{th} Mar. 2020 |
| Wind | No wind from | No wind | Strong wind | No wind | No wind |
| Condition | Paraguay | coming from | coming from | coming from | coming from |
| | | Paraguay | Paraguay | Paraguay | Paraguay |
| | | | from 6 a.m. | | |
| | | | until 6 p.m. | | |
| Rain | Insignificant | No rain | Significant | No rain | No rain |
| condition | rain | | rain | | |
| | | | occurred | | |
| Spore | No spore | Spores not | Spores not | Higher | Lower |
| collection | collection | collected | collected | number of | number of |
| | | | | Spore | Spore |
| | | | | collection at | collection at |
| | | | | 500 m and | 500 m, 1000 m |
| | | | | 1000 m from | and 1500 m |
| | | | | ground | from ground |

From the above table and FIG. 2 it is evident that the apparatus of the present invention was able to collect Asian Soybean Rust spores in high altitudes from ground. Further, it was clear that only after a significant rain occurrence, collection of spores closer to the ground was possible which establishes that impact of rain occurrence was positive on the spore collection. Further, when occurred an intense wind stream from Paraguay to the Trial city, for period of 12 hours, it was possible to collect spores in high altitude from ground the following days. As the wind from 19th March changed direction, the number of collected spores on 20th March was lesser. More studies were conducted to corroborate confirm this observation in Example 2.

Example 2: Trials were conducted to validate the meteorological model to predict when the wind direct and the best days to fly the plane and capture fungal spores in high altitude from ground, and to check how spores collected in the ground, wind direction and rain are correlated with disease occurrence in Soybean areas of RS State in the season 2020/2021. Further, possibility to capture spores coming from rain was evaluated.

Collection of Spores at High Altitude from Ground:

The apparatus for collecting fungal spores according to the present invention was attached to an Aircraft and remotely operated from cockpit to fly in São Luiz Gonzaga City, Rio Grande do Sul State, Brazil. The days chosen to fly were 30 Sep., 1 Oct., 15 Oct., 16 Oct., 19 Oct., 20 Oct., 6 Nov., 23-25 Nov. 2020 and 5 Jan. 2021. These days were selected with the aid of a meteorological prediction of wind direction, so that the aircraft could be operated under different wind direction to check its effect on the number of collected spores. A specific flying time of 3 pm was adhered when meteorological conditions were more favorable to spores moving due to thermic inversion.

The pilot inside the cockpit opened chambers of the apparatus when the desired altitude is reached using a remote radio control. Each chamber in the apparatus of the present invention comprised a fixed microscopical glass blade with a sticker to retain the spore when opened. The chambers were opened at altitudes 500 m and 1000 m from the ground, respectively. Each chamber was opened for 20-25 minutes, only one chamber was opened at a time. During flying between the altitudes and/or during the takeoff and landing, the chambers were kept closed to avoid interference of particles and spores at undesired heights or closer to the ground. After collecting the spores from desired altitudes of 500 m and 1000 m from the ground, the blades from each chamber were removed and taken to laboratory for counting spores.

A meteorological model to predict wind direction was made. The model predicted the wind direction and behavior to guide the spore collections in high altitude from ground. Sentinel areas were monitored.

Collection of Spores at High Altitude from Ground:

A ground spore trap and a rain gauge were placed in two cities: Santo Angelo—RS and Santa Maria—RS, which were 80 and 250 km, respectively, far from the aircraft in São Luiz Gonzaga—RS. Ground collections were made for one hour after the aircraft take off. In addition to Santo Angelo And Santa Maria, all RS State were monitored using commercially available ground spore collection devices.

### Results:

FIGS. 3 and 4 show the Meteorological Forecast Reports which were used to guide the aircraft. FIG. 7a-7c shows microscopic images of Phakospora Pachyrhizi collected from the high altitudes. The below Table 2 shows the number of spores collected at ground level and at altitudes 500 m and 1000 m from the ground level.

TABLE 2

| | | | Year: 2020 | | | | | | | | | | Year: 2021 |
|---|---|---|---|---|---|---|---|---|---|---|---|---|---|
| Type of | Altitude | | 30th | 1st | 15th | 16th | 19th | 20th | 6th | 23th | 24th | 25th | 5th |
| collection | from ground | | Sep | Oct | Oct | Oct | Oct | Oct | Nov | Nov | Nov | Nov | Jan |
| Aircraft | 500 | m | 7 | 172 | 49 | 19 | 9 | 8 | 4 | 2 | 2 | 2 | 0 |
| Aircraft | 1000 | m | 8 | 98 | 31 | 19 | 21 | 25 | 5 | 3 | 3 | 3 | 0 |
| Ground | 2 | m | 0 | 42 | 132 | 25 | 19 | 25 | 7 | 4 | 7 | 0 | 0 |
| collector | | | | | | | | | | | | | |

FIG. 8 shows a graphical representation of the number of spores collected at high altitudes from ground. It can be seen from the FIG. 3 that the wind intensity from Paraguay entering the Brazil region was >50 km/h for upto 12 hours on September 30th. From FIG. 8, it is evident that one day later from heavy wind intensity, i.e. on October 1st high number of spores collected when compared to the collection of spores on September 30th. Further, it can be seen from the FIG. 6, 10 mm rain occurred on 14th October. From FIG. 8, it is evident that one day later from rain occurrence, i.e. on October 14th high number of spores collected at the ground level when compared to the collection of spores at high altitudes.

Therefore, it is conclusive that the meteorological model was an important guide to determine the collection time. From the above examples and figures it can be concluded that when the forecast predicted high wind intensity from Paraguay, the spore collection in the high altitude above ground level was more. Similarly, when the wind intensity was not favorable, the number of spores collected were less.

Example 3: Comparative study for collection of spores at ground level was done at Rio Grande Do Sul State for Asian Soybean Rust (ASR) detection in commercial areas. Commercially available below listed data sources were used.
1. For ground spore detection—http://emater.tche.br/site/monitora-ferrugem-rs/home
2. For ARS detection in commercial areas—http://www.consorcioantiferrugem.net/
3. For wind direction occurrence—www.ventusky.com
4. For rain occurrence—https://www.agritempo.gov.br/agritempo/index.jsp

FIG. 9 represents Asian Soybean Rust occurrence map for RS State in the season from January to March 2021. Each row of the map represents each municipality in the RS State. Each column represents the day. A total of 61 municipalities of RS State were considered under this study. The representations in the map are as below:
‘x’ indicates identification of ASR in the soybean field.
[symbol] indicates the day from which a first ASR spore was detected in ground collectors.
[symbol] indicates the day on which wind streams from Paraguay started.
[symbol] indicates days with 5-10 mm rain.
[symbol] indicates days with 10-15 mm rain.
[symbol] indicates days with more than 15 mm rain.

From FIG. 9, it was evident that for all RS State municipalities, the occurrence of ASR in commercial soybean fields was detected after wind streams from Paraguay of 50 km/h at 1000 m lasting for a minimum of 12 continuous hours and followed by rain of at least 5 mm/day, in the very next days. For 24 municipalities, ASR symptoms were detected after the collection of Phakopsora Pachyrhizi closer to the ground. On average, 21 days after the detection of spores in the ground, first symptoms of ASR were identified for these 24 municipalities. For 98% of RS State municipalities, ASR symptoms were detected after the occurrence of a minimum 5 mm/day rain days before. On average, 5-6 days after the 5 mm/day rain was necessary interval for identification of first ASR symptoms in these municipalities. On average, 10-11 days with minimum 5 mm/day rain was necessary in the interval of 20 days for first ASR symptoms to be detected in 98% of municipalities. On average, 7-8 mm/day rain was necessary in the interval of 20 days for first ASR symptoms to be detected in the 98% of municipalities. For 98% of RS State municipalities, ASR symptoms were only detected after the occurrence of altitude wind streams from Paraguay soybean regions. On average, 13 days after the last 50 km/h wind was necessary for the first ASR symptoms to be detected in the 98% of municipalities.

It can be concluded that prediction of Asian Soybean Rust in commercial Soybean fields of RS State was not possible by simply monitoring spores collected in ground collectors, as for 37 regions of 61 in totality, the disease symptoms were detected before spore's collection.

There were 136 registered Asian Soybean Rust occurrences in commercial crop areas from 61 municipalities from Jan. 1 to Mar. 15, 2021. For 20% of the total detections and 60% of municipalities, the disease was registered prior to the spore collection by the ground collector. On the other hand, for 98% of all occurrences and municipalities, the disease symptoms were detected after wind from Paraguay, followed by rain occurrence in the very next days. Both the wind direction and rain occurrence showed to be the two more reliable variables to predict the ASR occurrence in the RS State.

Therefore, the present invention advantageously detects Asian Soybean Rust even before the spore reaches the ground level. Thus, enabling farmers to understand the origin of spores, its effectiveness and genetic differentiation, as well as the level of risk associated with meteorological conditions like wind direction and rain forecast.

1. An apparatus for collecting fungal spores from atmosphere comprising:
a container of closed structure,
first chamber, and
a first actuator,
wherein the chamber is adapted for introducing at least one sample blade which comprises an adhesive layer and being adapted for capturing fungal spores, and
wherein the actuator enables opening and closure of the chamber.

2. The apparatus according to claim 1, characterized by the chamber being connected to one inside end of the container, and the actuator connected to the closed end of the chamber.

3. The apparatus according to claim 1, characterized by the apparatus being capable of connected to a flying means.

4. The apparatus according to claim 1, characterized by the chamber comprising a tray to receive the sample blade.

5. The apparatus according to claim 1, characterized by comprising:
the first chamber being connected to one inside end of the container,
a second chamber being connected to one inside end of the container,
a third chamber being connected to one inside end of the container,
the first actuator connected to the closed end of the first chamber,
a second actuator connected to the closed end of the second chamber, and
a third actuator connected to the closed end of the third chamber.

6. The apparatus according to claim 1, characterized by the chamber being configured to open and close at a predetermined altitude ranging from 100 m to 10,000 m above the ground level for predetermined interval of time at least of 1 minute.

7. A method of collecting fungal spores from atmosphere comprising:
a. attaching the apparatus as defined in claim 1 to a flying means;
b. allowing the flying means to reach a predetermined altitude from the ground level;
c. opening the first chamber containing at least one sample blade by activating the first actuator using a control means when the flying means reaches a predetermined altitude;
d. allowing the chamber to collect spores from the atmosphere;
e. allowing the flying means to return to the ground level; and
f. removing, from the chamber, the sample blades containing spores collected from atmosphere.

8. A disease warning system comprising:
a) the apparatus as defined in claim 1, and
b) a control unit operatively coupled to said apparatus and configured to send and/or receive data pertaining to any or a combination of collected fungal spores, data pertaining to metrological conditions and/or data pertaining to any or a combination of agricultural field.

9. The disease warning system as claimed in claim 8, wherein the data pertaining to any or a combination of collected fungal spores are selected from the group consisting of species of fungi, sensitivity of spores, number and viability of spores, result from identification of spores with resistance genes, result from evaluation of disease evolution in fields closer to the apparatus, agrochemicals to-be-used, and comparison result to the data collected at the ground level.

10. The disease warning system as claimed in claim 8, wherein
the data pertaining to metrological conditions are selected from a group consisting of wind predominant direction at the collecting altitudes, wind intensity, rain forecast, and rain intensity.

11. The disease warning system as claimed in claim 8, wherein
the data pertaining to any or a combination of agricultural field are selected from the group consisting of polygon coordinates of agricultural area, crop name, and sowing date.

12. The disease warning system as claimed in claim 8, which enables bifurcation of disease risks at one or more regions from low risks to high risks.
